(19) United States
(12) Patent Application Publication
(10) Pub. No.: US 2009/0177534 A1
(43) Pub. Date: Jul. 9, 2009

(54) SYSTEM FOR PERFORMING PERSONNEL EVALUATIONS AND COMPUTER PROGRAM THEREOFOR

(75) Inventors: AMIT ARORA, Delhi (IN); Jyoti Rai, New Delhi (IN); Naveen Jain, Haryana (IN); Vaibhav Sharma, New Delhi (IN); Ruchika Arun, New Delhi (IN); Shino Joseph, Pin (IN); Amit Goel, Delhi (IN)

Correspondence Address: FITZPATRICK CELLA HARPER & SCINTO, 30 ROCKEFELLER PLAZA, NEW YORK, NY, 10112, US

(73) Assignee: American Express Travel Related Services Co., Inc., New York, NY (US)

(21) Appl. No.: 11/970,298

(22) Filed: Jan. 7, 2008

(51) Int. Cl. G06Q 90/00

(52) U.S. Cl. 705/11

(57) ABSTRACT

A computer system and computer program product are provided that enable a supervisor to input performance evaluations for members of the supervisor's group. The supervisor is presented with an electronic evaluation form that includes evaluation items that are answered by the supervisor selecting one of a plurality of options. The evaluation form evaluates parameter, sub-parameters, skill types and skill levels as established during maintenance. Each evaluation item is categorized by at least a parameter, sub-parameter, skill type, or skill level. Answers to the evaluation items inputted by the supervisor for each of the members of the group are used to produce a graphical evaluation result based on the answers inputted by the supervisor. Consolidation of several evaluations, from the same supervisor or from several, can also be done.

### BACKGROUND OF THE INVENTION

The present invention generally relates to personnel evaluations in an organization. More particularly, the present invention relates to a computer system and computer program for use in performing such evaluations and that enable a supervisor to input performance evaluations for members of a group and to view evaluation results graphically.

Generally, supervisors are directly responsible for the productivity and actions of small groups of employees or members. As such, supervisors need constantly to monitor and evaluate the performances of the group of members to determine strengths and weaknesses of each of the members' skills and performances. This enables supervisors to identify areas in which improvement may be required, and to address problems. It is often difficult, however, to keep track effectively of all the individuals and their performance. Furthermore, pinpointing areas in which improvement is necessary may be difficult. Time constraints and a lack of effective tools in the present market also impede supervisors in effectively and efficiently evaluating members within their supervisory group, leading to missed opportunities for improvement of efficiency.

If it is sometimes difficult for the individual supervisor to keep track of and manage skill and performance development among the members of the supervisor's group, it can be even more difficult for a higher-level manager to obtain an accurate and up-to-date overall view of the performance, skill level, etc., of staff in various portions of the business organization for which the manager is responsible, or to identify portions in which particular problems are occurring.

Given the foregoing, a need exists for a computer system and computer program product that effectively and efficiently enables a supervisor of a group of members to evaluate members in the group. There is also a need to be able to quickly view the results of these evaluations in a useful format quickly, and especially for results from a number of evaluations to be collated and the results viewed in a way that is convenient and easy to understand.

### BRIEF DESCRIPTION OF THE INVENTION

To avoid confusion, the following terms will be used herein with specific meanings, as follows:

As used herein, “supervisor” means anyone who is responsible for the performance of another person or a group of people.

As used herein, “member” means a person who, either alone or as part of a group, is under the supervision of another.

As used herein, “organization” means an entity comprising a group of people working towards at least one goal.

As used herein, “user” means any individual operating a computer implementing one or more aspects of the present invention.

As used herein, “business area coordinator” means an individual who oversees the activities and/or performance of one or more supervisors.

As used herein, “interface” is means by which a user interacts with a computer program or system.

As used herein, “personnel” means any person or persons employed by an organization.

As used herein, “authorized user” is a user who has the authority to perform functions that at least some other users do not.

As used herein, “parameters” are characteristics or factors that can be relevant in evaluating an employee.

As used herein, “sub-parameters” are subsets of “parameters,” in which characteristics or factors that can be relevant in evaluating an employee are broken down in further detail. As an example, a broad category such as “functional” might be chosen as one parameter, and a number of more specific abilities, e.g., knowledge of accountancy, efficiency, business knowledge, might be used as sub-parameters.

The present invention meets the above-identified need by providing a system and a computer program product that allow a supervisor of a group in an organization to input performance evaluations for one or more members of the group. The product presents an electronic evaluation form to the supervisor that includes evaluation items that are to be answered by selecting one of a plurality of options for each item.

An advantage of the present invention is that the electronic evaluation form is user-friendly, making it easy for a supervisor to input answers into the electronic evaluation form. Furthermore, each evaluation item is categorized, further simplifying the evaluation. Another advantage is that the program can graphically display the results, and can do so in accordance with a user's preference, and in a way that is most meaningful to the particular user.

In accordance with an embodiment of the present invention, an authorized user performs maintenance to the evaluation program, which includes, among other things, adding, deleting and editing evaluation items. The evaluation items are categorized by, for example, parameters, sub-parameters, skill types (more-specific skills within a given sub-parameter) and skill levels. There can be any number of evaluation items for which a member of a group can be evaluated. To ensure that only authorized users perform maintenance, password security is provided. Once the authorized user has established evaluation items and completed maintenance, the file can be transmitted electronically to a supervisor or stored for later use by a supervisor. The supervisor, after logging in, uses the evaluation items in the form to input answers and complete his or her evaluation of the member. After a supervisor has evaluated a member of the supervisor's group, the supervisor can either save the evaluation for updating or completion at a later time, or indicate its completion by a finalizing feature. The computer program also has a feature to export files once the evaluation form has been completed and indicated as finalized. The export feature copies the data contained in the evaluation file and compresses it, if necessary.

According to an embodiment of the present invention, a computer program product comprising a computer-usable medium having control logic stored therein for an evaluation program is provided. This computer program product causes a computer to enable a supervisor of a group in an organization to input performance evaluations for members of the group. The control logic includes first computer-readable program code for causing the computer to present to the supervisor an electronic evaluation form that includes evaluation items that are answered by selecting one of a plurality of options, wherein the evaluation form evaluates at least: a plurality of parameters, a plurality of sub-parameters, a plurality of skill types, and a plurality of skill levels, and wherein each evaluation item is categorized by at least: a parameter, a sub-parameter, a skill type, and a skill level. The control logic also includes second computer-readable program code for causing the computer to receive answers to the evaluation items inputted by the supervisor for each of the members of the group. The control logic further includes third computer-readable program code for causing the computer to produce a graphical evaluation result based on the answers inputted by the supervisor.

In accordance with another embodiment of the present invention, a computer system comprising a processor and a memory storing control logic for causing the processor to enable a supervisor of a group in an organization to input performance evaluations for members of the group is provided. The control logic includes first computer-readable program code for causing the computer to present to the supervisor an electronic evaluation form that includes evaluation items that are answered by selecting one of a plurality of options, wherein the evaluation form evaluates at least: a plurality of parameters, a plurality of sub-parameters, a plurality of skill types, and a plurality of skill levels, and wherein each evaluation item is categorized by at least: a parameter, a sub-parameter, a skill type, and a skill level. The control logic also includes second computer-readable program code for causing the computer to receive answers to the evaluation items inputted by the supervisor for each of the members of the group. The control logic further includes third computer-readable program code for causing the computer to produce a graphical evaluation result based on the answers inputted by the supervisor.

### BRIEF DESCRIPTION OF THE DRAWINGS

Additional features and advantages of the present invention will become more apparent from the detailed description set forth below when considered in conjunction with the attached drawings. Additionally, the left-most digit of a reference number identifies the drawing in which the reference number first appears.

FIG. 1 schematically illustrates a system diagram of various features of an embodiment of the present invention.

FIG. 2 is a flow chart schematically illustrating use of that embodiment of the present invention.

FIGS. 3-11 show examples of an interface used in that embodiment.

FIGS. 12-17 each show an example of a different type of report generated in accordance with an embodiment of the present invention.

FIG. 18 schematically illustrates a system diagram of various features of an embodiment of the present invention.

FIG. 19 schematically illustrates a system diagram of an exemplary system used to implement an embodiment of the present invention.

### DETAILED DESCRIPTION OF THE INVENTION

### I. OVERVIEW

The present invention is directed to a system and a computer program that enable a supervisor of a group in an organization to evaluate and assess personnel by using an electronic evaluation form. In a preferred embodiment, the evaluation program is a spreadsheet program.

### II. SYSTEM

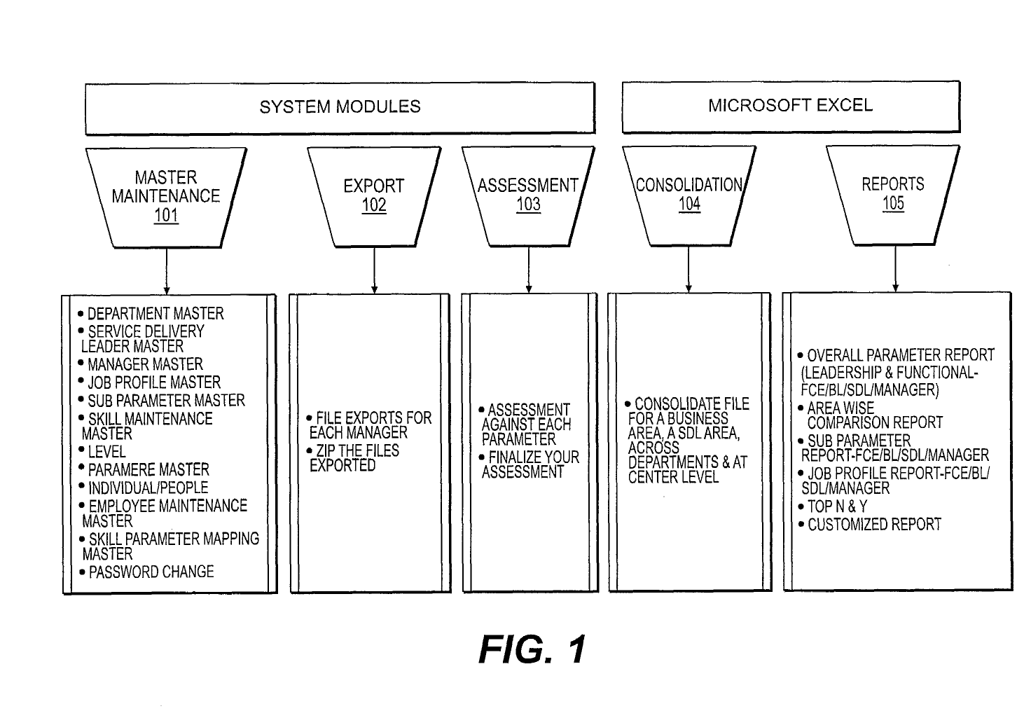

FIG. 1 shows a system diagram for various features of the computer program and system.

Maintenance feature 101 permits updating or other modifications of the electronic evaluation forms, including adding, editing and deleting evaluation items. Maintenance of an evaluation form updates one or more of a parameter, a sub-parameter, a skill type and a skill level. Maintenance of the program is, preferably, limited to authorized users. To ensure that only authorized users perform maintenance, at least one login interface with password security is provided. In a preferred embodiment of the present invention, only a business-area coordinator of the organization performs maintenance.

Maintenance feature 101 also permits adding, editing and deleting of mapping between an individual and a supervisor, and/or an individual's job profile and the supervisor. Maintenance feature 101 also permits adding, editing and deleting of supervisors, other members or management and department features, e.g., directors, department heads and department title. This feature allows an authorized user to set a hierarchical structure in order for a report to be generated and viewed in different forms, as discussed in detail below.

Preferably, yes/no questions or other quantitative formats, such as rating a person's performance as minimal/acceptable/exceeding, are established during maintenance to allow the supervisor to input evaluations quickly.

Export feature 102 allows a user to store the file and also to transmit files to another user. Files to be exported using the export feature can be compressed to reduce file size, for example, in a zip file format, prior to exportation. In a preferred embodiment of the present invention, an authorized user, following completion of maintenance, exports a file to the supervisor(s) who will use it.

Evaluation or assessment feature 103 allows a supervisor to assess an individual against the parameters, sub-parameters, skill type and skill level established in maintenance feature 101 by inputting information relating to the individual to be assessed. Once information is inputted, the computer program presents a ‘finalize’ option so that a user can indicate that the evaluation has been completed. Once the evaluation has been finalized, it is deemed to be ready for submission to another user, such as an authorized user. Once the ‘finalize’ option has been selected, the report may then be available for a user to view one or more aspects of the evaluation, e.g., areas that may affect an overall departmental score.

Consolidation feature 104 combines information from several evaluations. In particular, during consolidation, answers inputted by one supervisor can be correlated with answers inputted by at least one other supervisor. (This may be done to permit the authorized user to see how well the employees working for one supervisor compare with those working for another, but it is also within the scope of the invention for permit consolidation if for some reason a particular staff member reports to, and is evaluated by, more than one supervisor.) If consolidation is performed, a graphical evaluation result may be used to depict a combination of the answers, or of a subset of the answers, from the respective evaluations that have been consolidated. A graphical evaluation result can be generated comparing at least a subset of the answers inputted by one supervisor and at least a subset of the answers inputted by the other supervisor(s). Graphical evaluation results are discussed further in detail below. These supervisors can be in the same or different business areas of the organization. Consolidation and/or correlation may be performed at essentially any level within the organization, and thus the number of evaluations being consolidated may range from two up.

Report feature 105 generates a graphical evaluation result based on one or more of the evaluations before or after consolidation. Various types of reports can be generated, and the invention is not limited to those explicitly listed herein. Graphical evaluation results can be in the form of a spreadsheet, a pie chart, a bar-graph chart or a histogram, to name a few. Examples of types of reports are a graphical parameter report, a graphical sub-parameter report, a graphical profile report, a top-ten report, and a department comparison report, relating to at least one of the plurality of skill levels. The computer program and system also allow these reports to be printed.

In yet another embodiment of the present invention, a user or authorized user can select a subset of answers inputted by a supervisor and obtain a graphical evaluation that depicts the selected subset.

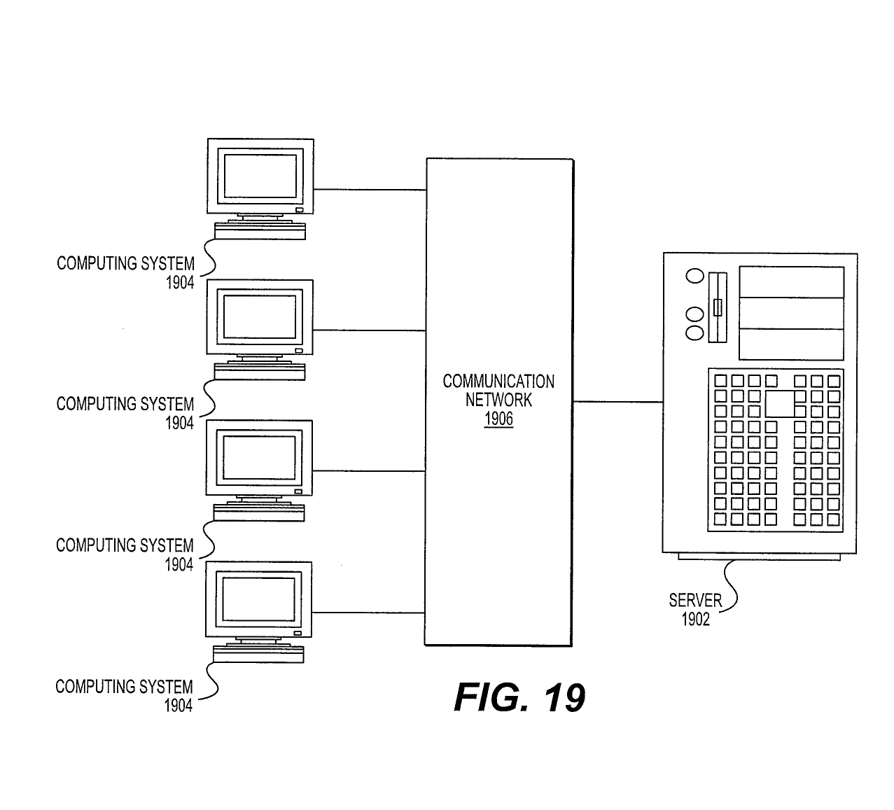

FIG. 19 shows a schematic system diagram of an exemplary system for performing personnel evaluations used to implement or practice one or more embodiments of the present invention. The system includes a server 1902 interconnected with one or more computing systems 1904 via a communication network 1906. Communication network 1906 may be the Internet, a public switched telephone network (PSTN), or any other means of communication between server 1902 and computing system(s) 1904, whether wired or wireless. Computing system 1904 may be used by a supervisor or any other user to communicate with other supervisors, business area coordinators or any other users generally, and may be a personal computer, a workstation, a mainframe computer, a kiosk, a personal digital assistant, or any other digital device able to perform data communication with server 1902.

In a preferred embodiment, the computer program according to the present invention may be stored on the server 1902 and accessible by computing systems 1904. In another embodiment, the computer program may be stored directly on the computing systems 1904, in which case the computer program would be reloaded every time an update is made.

Optionally, to ensure security, communications may occur indirectly with server 1902 through a security filter (not shown) such as, for example, a firewall, which may be implemented with hardware, software, or a combination thereof. Other types of security measures may be employed, as will be appreciated by persons of skill in the relevant art(s).

### III. PROCESS

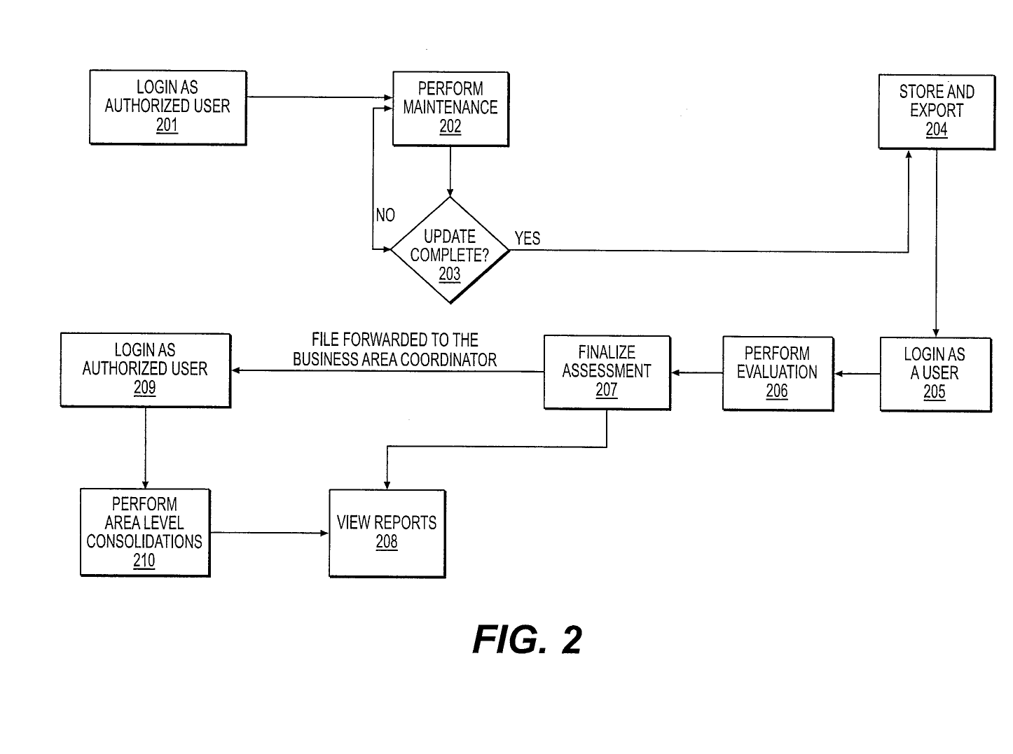

FIG. 2 shows a flow chart illustrating use of the present invention.

In step 201, an authorized user can log in to access the system. The authorized user then performs maintenance 202 of the evaluation program, which includes adding, editing and deleting evaluation items. After the authorized user has completed maintenance, it is confirmed at step 203 that the evaluation program and evaluation items have been updated.

In the event that the authorized user indicates that the evaluation items have not yet all been updated as intended, the process returns to step 202 for further maintenance. If it is determined that the evaluation items will not be further updated at present, the files can be stored and are available for exporting to another user in step 204, typically to a supervisor for use in an evaluation.

Once the files have been saved or exported, a supervisor may begin an evaluation. The supervisor can log in at step 205. For each of the evaluation items established by the authorized user in step 202, the supervisor inputs answers for individuals in his or her group into the evaluation form in step 206. Once the supervisor has completed his or her evaluation of the individual, the supervisor can either save the inputted data for later (not illustrated) or mark the evaluation as complete (‘finalize’ the evaluation).

Once the evaluation has been indicated as finalized in step 207, the user can choose to generate a graphical evaluation report from the information inputted during the evaluation. The report can be any type of report, but for example, can be a spreadsheet, a pie chart, a bar-graph chart, a histogram, or any combination thereof.

According to another embodiment of the present invention, once the supervisor in step 207 finalizes the evaluation, the file can also be forwarded to an authorized user. This authorized user can be the same authorized user who prepared or updated the form, or a different authorized user. After logging in at step 209, the authorized user can perform consolidation in step 210. Consolidation involves unifying a plurality of evaluations. A particular manner in which the consolidation is to occur can also be specified. For example, area-level consolidations can be performed to determine the strength of a business area and enable comparisons between different business areas.

Once the consolidation has been completed, a graphical evaluation result for the some or all of the consolidated information can be generated as a report in step 208. These reports can be one or more of the types of reports listed above.

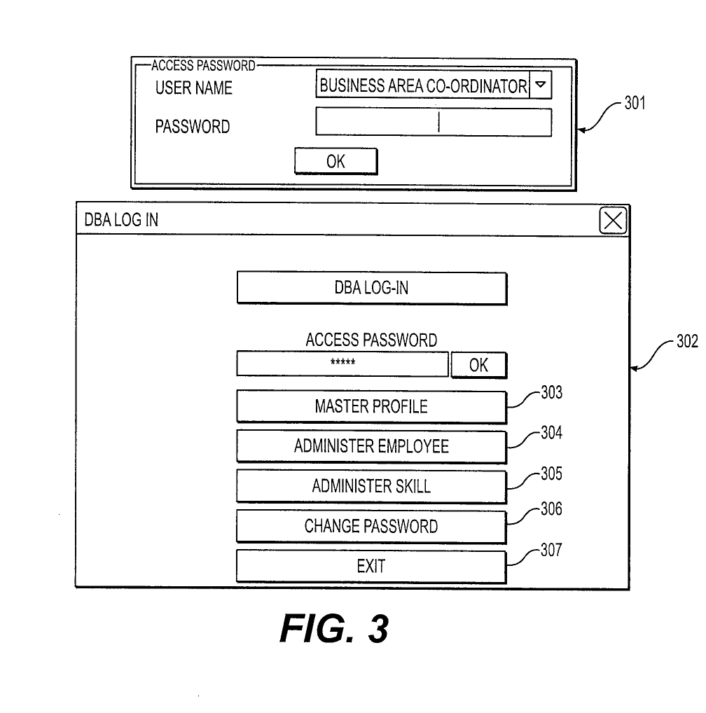

FIG. 3 shows an example of login interfaces 301 and 302 for an authorized user in accordance with one embodiment of the present invention. Password security is provided on two levels. The first login interface 301 identifies the user, and the second login interface 302 determines whether the user is authorized to perform maintenance. After successful login, the authorized user can select from among the various actions that an authorized user can perform. For examples, these actions (explained below) include, but are not limited to, master profile 303, administer employee 304, administer skill 305, change password 306 and exit 307.

‘Master Profile’ 303 provides access to updating and other modification of the evaluation forms, including adding, editing and deleting evaluation items. ‘Administer Employee’ 304 provides access to updating and other modification of employee profiles, for example, linking an employee to the appropriate supervisor. ‘Administer Skill’ 305 provides access to updating and other modifications for skills parameters, sub-parameters, skill types and skill level, for example. ‘Change Password’ 306 provides access for updating and other modifications relating to passwords for various users. ‘Exit’ 307 navigates the authorized user away from the screen and to another interface (and can also log the authorized user out).

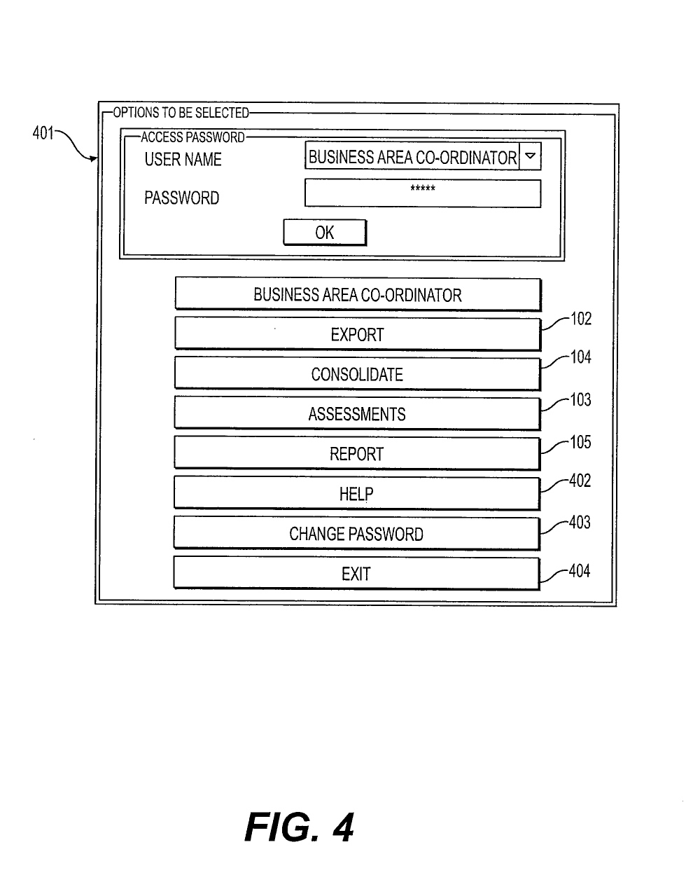

FIG. 4 shows the various features of the program available to an authorized user. Once the user has logged in, a plurality of features are available to the authorized user through the interface 401. Features 102-105 correspond t o the broad functions shown in FIG. 1, and need not be discussed further. ‘Help’ 402, ‘change-password’ 403 and ‘exit’ 404 keys are also provided to facilitate user navigation.

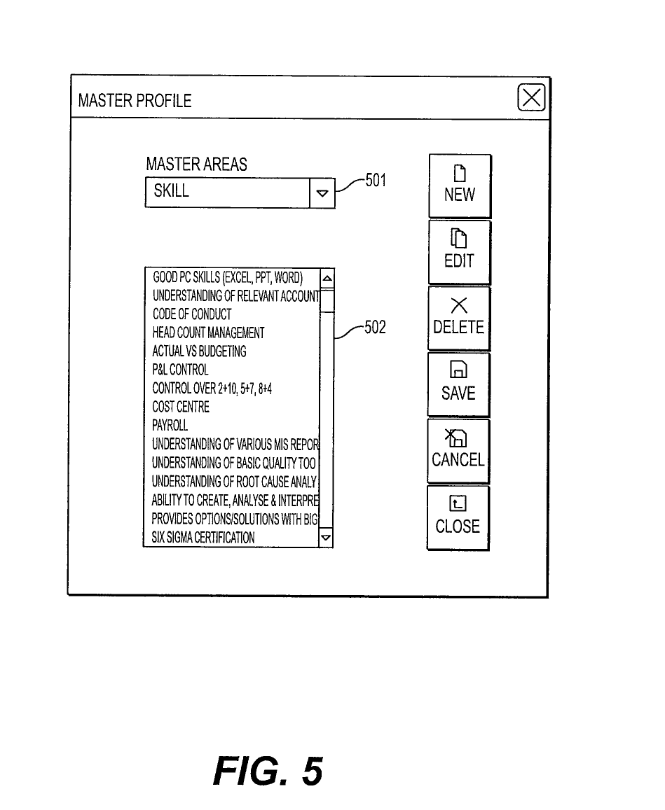

FIG. 5 shows an example of an interface for creating, editing and deleting various evaluation items used to assess an individual. Once a master area 501 is chosen, a number of evaluation items 502 are available for an authorized user to select from. These may include such varied domains as skill in using basic software applications, aspects of budget management, certifications, conduct, etc.

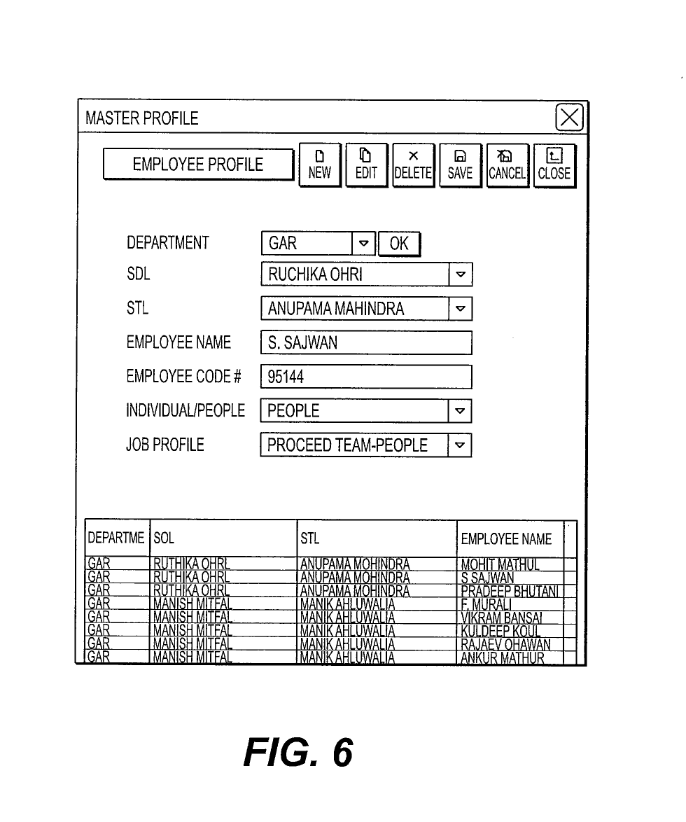

FIG. 6 shows an example of an interface for viewing and updating employee profiles. Various parameters or fields are provided for the authorized user to fill with the relevant information about the employees for whose evaluations that authorized user is preparing the evaluation forms. For example, these fields can include the name of the department that the employee works in, an identification number or code for the employee, and the names of managers, supervisors, leaders and the like whom the employee works with. Drop-down menus can also be provided for ease in completing the fields, As can be seen from FIG. 6, each employee is identified, inter alia, by the name of his or her immediate supervisor (in the ‘STL’ column), and higher-level supervisor (in the ‘SDL’ column). This allows a user to view an overall department features and scores in a hierarchical manner, and so allows a user more easily to select parameters and sub-parameters to be viewed in a graphical report.

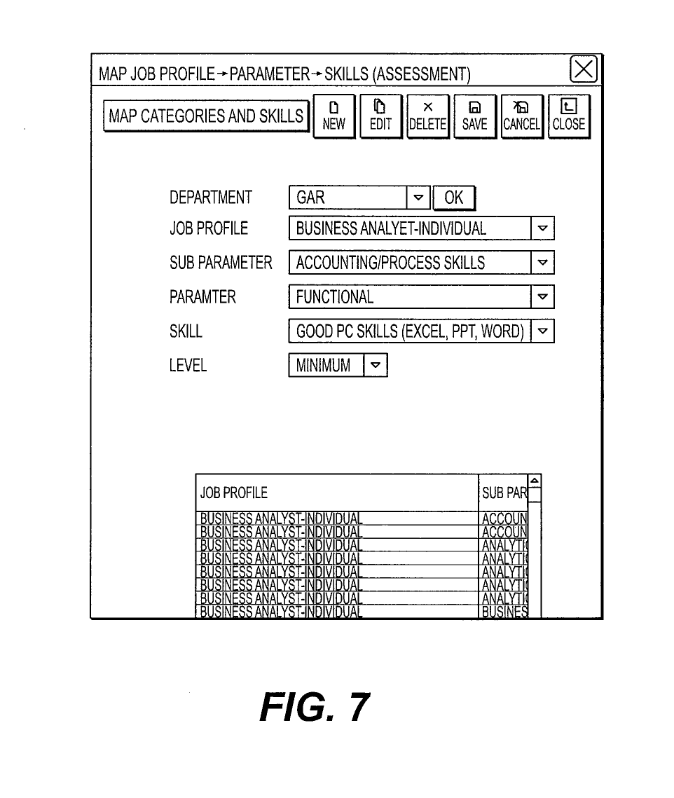

FIG. 7 shows an example of an interface for viewing map categories and skills. This interface can allow an authorized user to link a skill to a parameter or sub-parameter which can be further linked to a job profile of an employee and enter information regarding a given parameter or sub-parameter (it will be understood that this is not the entry of an assessment of the employee, but rather the selection of the given parameters and sub-parameters as being relevant for when the supervisor prepares that person's evaluation). A particular skill can be associated with the employee as well as the level at which the employee should perform or is performing.

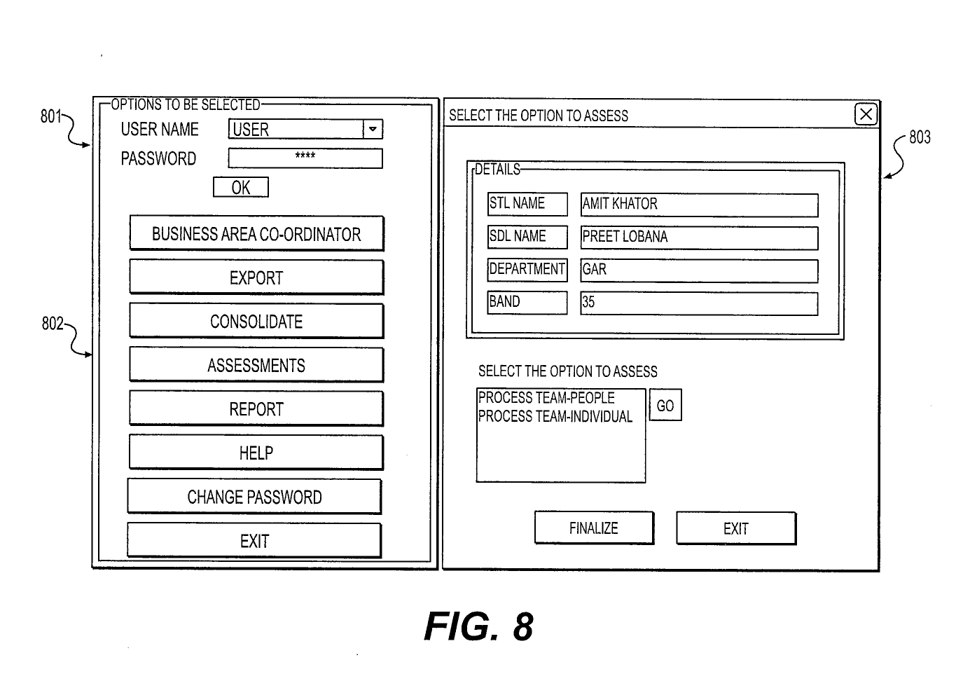

FIG. 8 shows an example of the interface to access an evaluation form. Once the supervisor, who is now the user, has logged in at the login interface, and selects the assessments key, a second interface 803 becomes available for the supervisor to input answers relating to the individual. At this interface, the user also has the option to ‘finalize’ the evaluation to indicate when the evaluation has been completed, or exit the interface completely. Once the ‘finalize’ option has been selected, the report may then be available for a user to view one or more aspects of the evaluation, e.g., areas that may affect an overall departmental score.

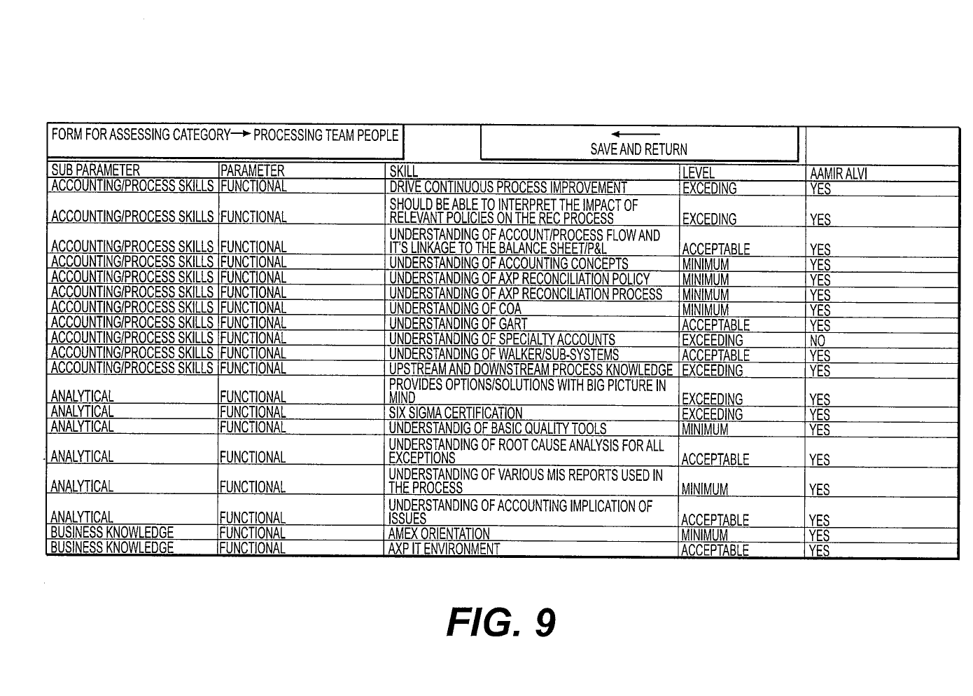

FIG. 9 shows an example of an evaluation form in accordance with one embodiment of the present invention. The evaluation form can be accessed from the interface shown in FIG. 8. Using spreadsheet functionality, a user can view the various sub-parameters, parameters, skills, and skill levels (the skill levels being the actual evaluation ratings that the user has entered) for a given employee. Spreadsheet functionality enables the user to evaluate a plurality of individuals using a given set of similar or the same criteria or questions. Individuals with common features can easily be grouped using filtering features that are common in spreadsheets.

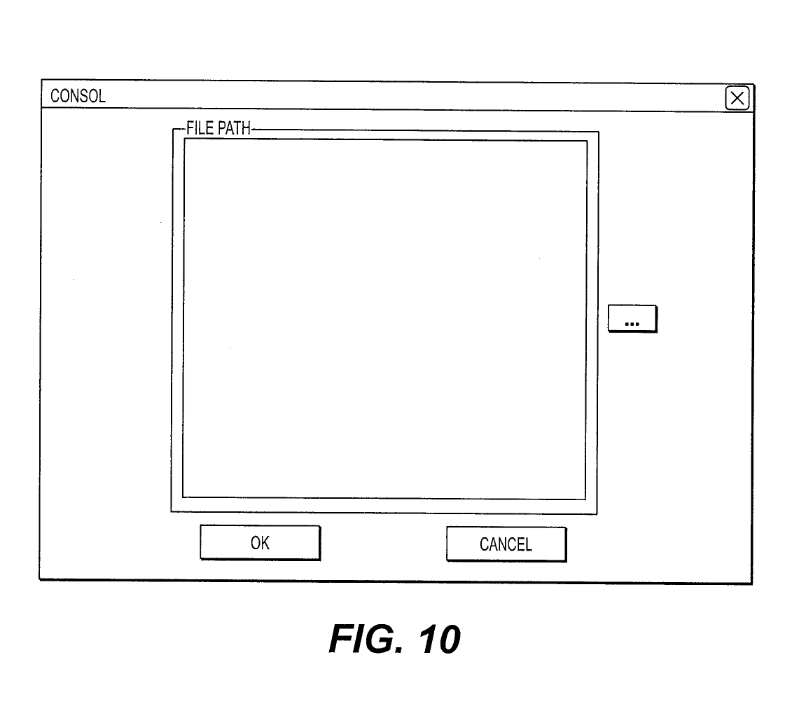

FIG. 10 shows an example of an interface to be used subsequently by an authorized user, to consolidate finalized evaluations. A file path for evaluations to be consolidated can be established using this interface.

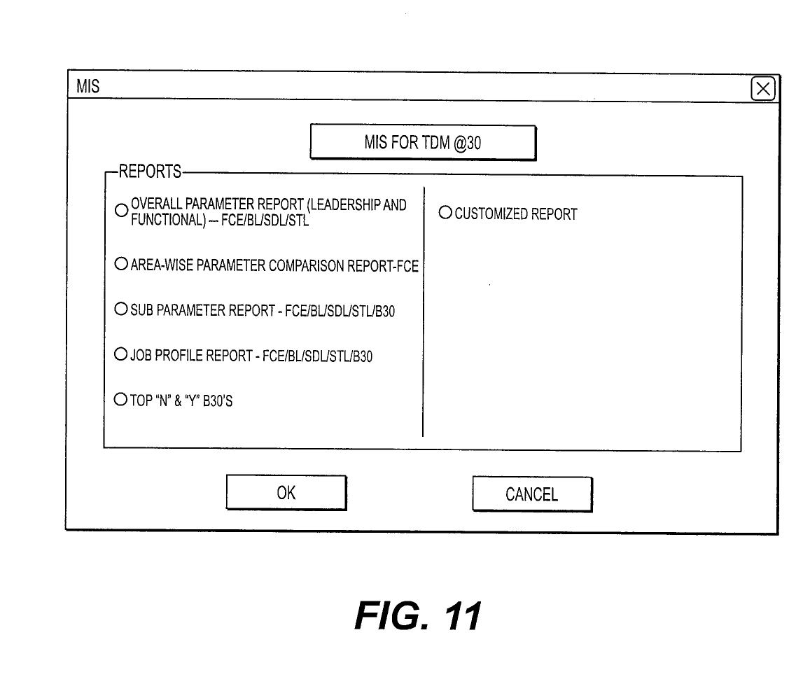

FIG. 11 shows an example of an interface allowing a user to select a type of report to be generated. For example, this example interface shows the interface to allow a user to choose from among the available reports. In this embodiment, these include an overall-parameter report, an area-wise parameter comparison report, a sub-parameter report, a job profile report, and a top-ten report. The user also has the option of constructing a customized report.

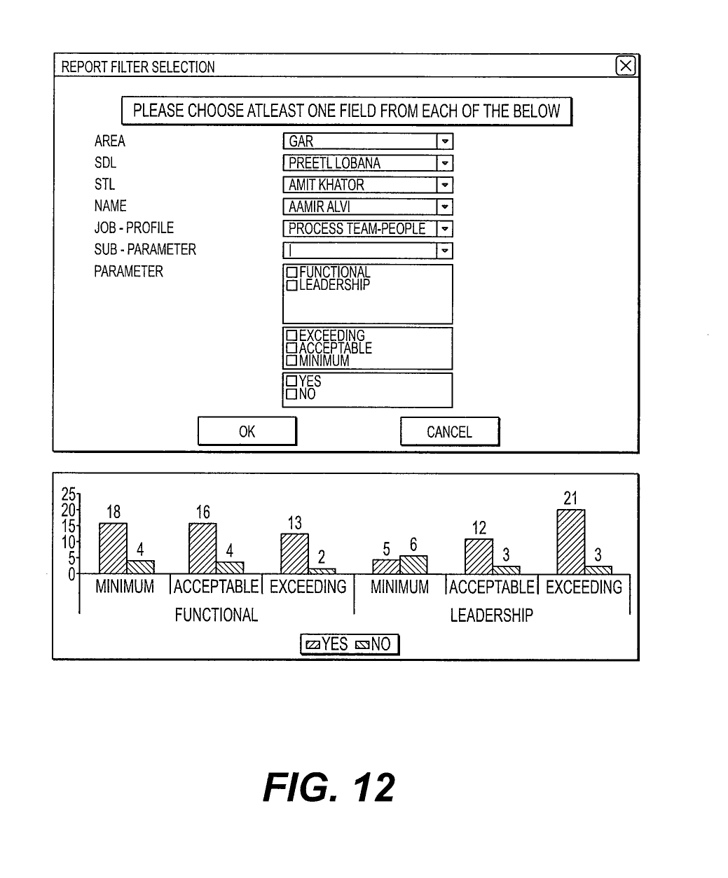

FIG. 12 shows an example of an overall-parameter report in accordance with one aspect of the present invention. The overall parameter report can graphically show a picture of how well or poorly a particular set of employees is performing. The report can provide a broad overview of employee performance, but also can provide a more detailed breakdown of employee performance, for example, by using ‘minimum,’ ‘acceptable’ and ‘exceeding’ ratings. (The invention is not limited to the use of three levels of rating, and a larger number can be used, if desired.) That set of employees may be simply all the employees in one unit, which could be either a very small unit or a rather large one. It is within the broad scope of the invention, however, that the set of employees whose evaluations are to be consolidated can be defined on other bases than the employees' location in an organizational chart. The overall-parameter report is shown as a bar graph, but can be any other type of graph. Spreadsheet functionality provides the user with added flexibility to view the report in various configurations using the filters provided in the spreadsheet. For example, these filters can be any parameter, sub-parameter, skill type, skill level, and/or any other feature used to describe and/or evaluate an employee, supervisor, department head, department, and the like.

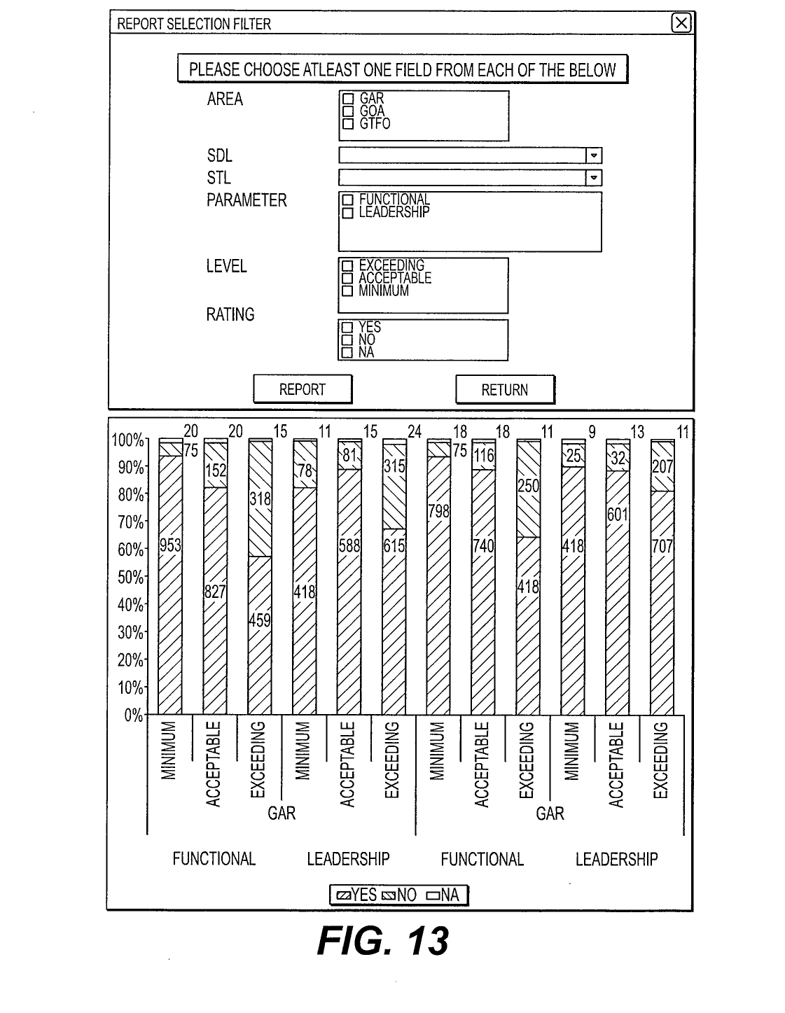

FIG. 13 shows an example of an area-wise parameter comparison report in accordance with one aspect of the present invention. The area-wise parameter comparison report graphically depicts the overall status to highlight and compare the strengths and weaknesses of at least at least two business areas (here, identified respectively as ‘GAR’ and ‘GTFO’). This report is similar to that shown in FIG. 12, but it can graphically show how well or poorly a particular department is performing. An overall picture of the department can be provided, as well as a more detailed breakdown of skill levels within the department. Comparison between different departments is also possible. Spreadsheet functionality once again provides the user with added flexibility to view the report in various configurations using the filters provided in the spreadsheet.

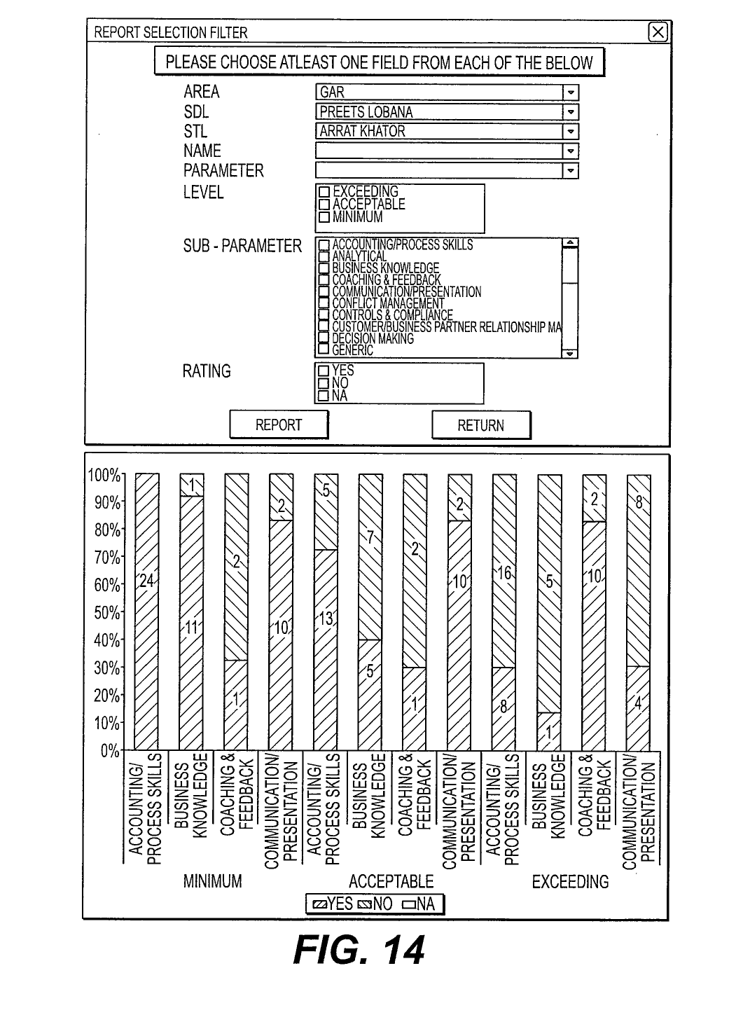

FIG. 14 shows an example of a sub-parameter report in accordance with another aspect of the present invention. The sub-parameter report can provide a user with a graphic view of the strengths and weaknesses with respect to a particular skill or a subset of a parameter, e.g., sub-parameter. These skills can include, for example, communication/presentation, coaching & feedback, business knowledge, accounting, and process skills. A user can easily see the number of employees falling within a certain performance level, e.g., minimum, acceptable and exceeding. Spreadsheet functionality once again provides the user with added flexibility to view the report in various configurations using the filters provided in the spreadsheet.

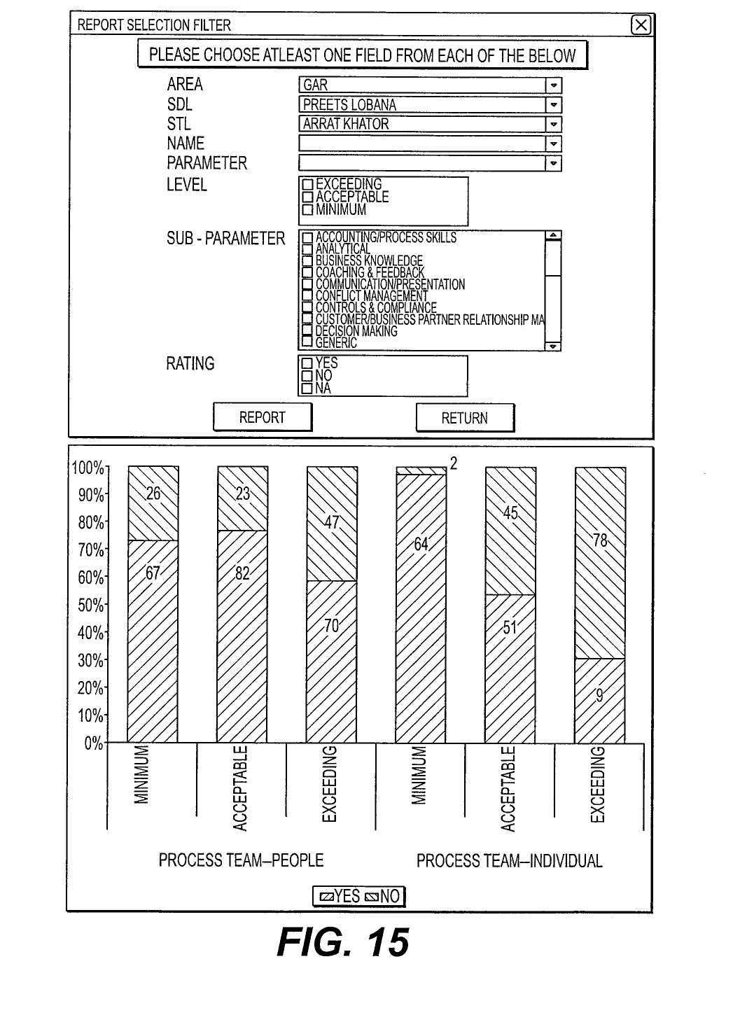

FIG. 15 shows an example of a job profile report in accordance with another aspect of the present invention. The job profile report displays where a supervisor stands with respect to job profiles to which the supervisor is mapped. This mapping can be further divided by skill level. Spreadsheet functionality once again provides the user with added flexibility to view the report in various configurations using the filters provided in the spreadsheet.

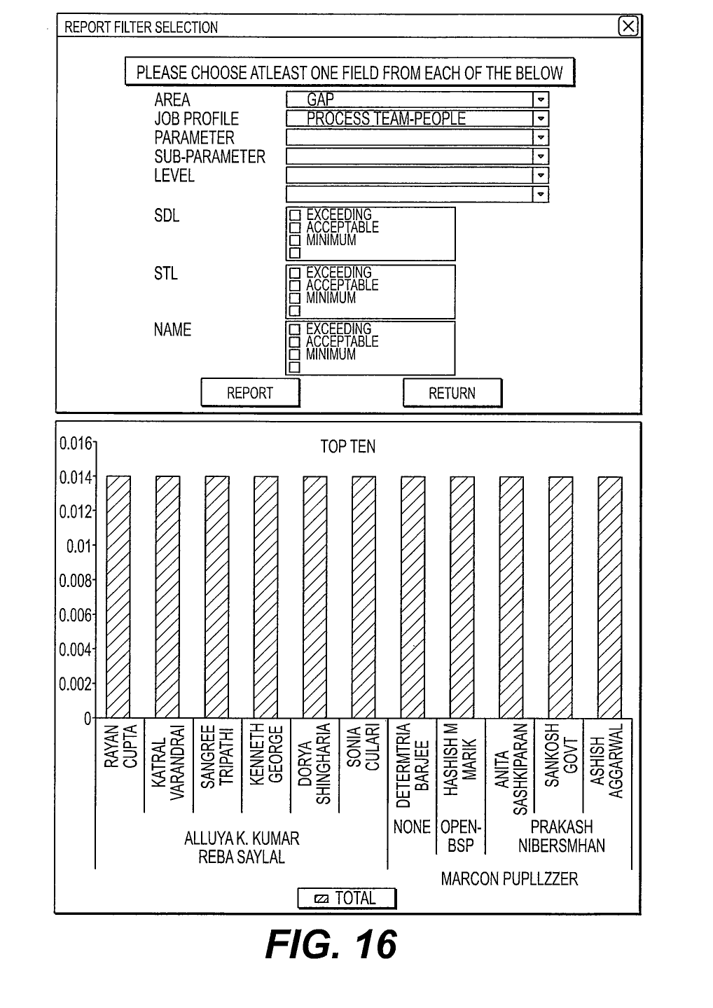

FIG. 16 shows an example of a top-ten report in accordance with yet another aspect of the present invention. This report allows the user quickly to view the best or the worst performers in any particular field. Preferably, the report shows the top ten and/or bottom ten performers. Of course, the invention is not limited to showing ten; a group of a different size could be used, and it is within the scope of the invention to permit an authorized user to set the size of this group. Spreadsheet functionality once again provides the user with added flexibility to view the report in various configurations using the filters provided in the spreadsheet.

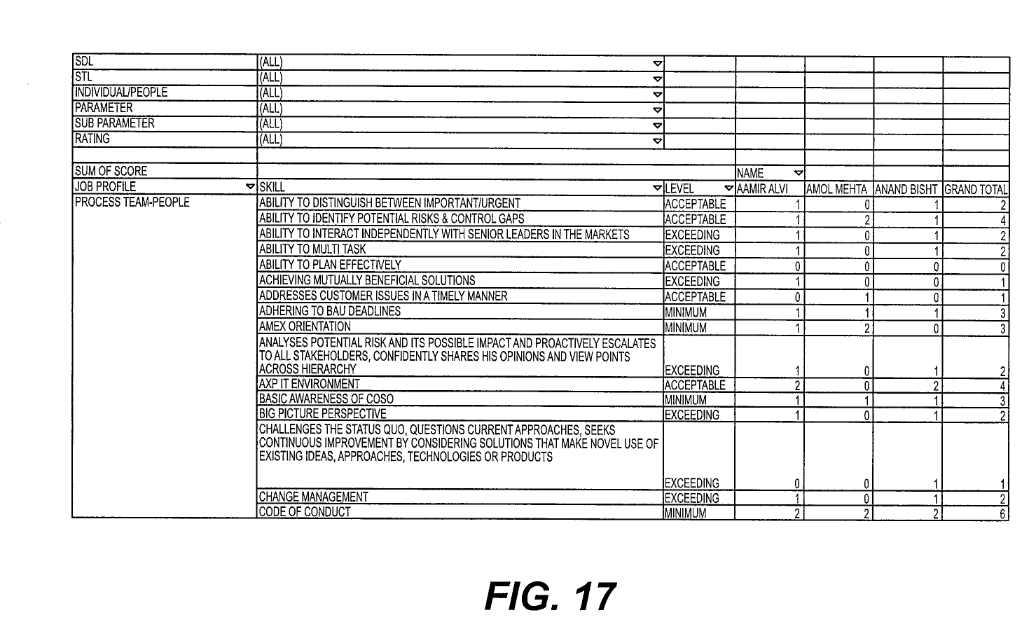

FIG. 17 shows an example of a customized report in accordance with another aspect of the present invention. The customized report gives a user the flexibility to generate a type of report desirable to the user. Preferably, the customized report is not a graphical report, but allows the user to view the fields and the data contained therein, as desired, preferably but not necessarily in spreadsheet form.

### IV. EXAMPLE IMPLEMENTATIONS

The present invention may be implemented using hardware, software, or a combination thereof, and may be implemented in one or more computer systems or other processing systems. Useful machines for performing some or all of the operations of the present invention include general-purpose digital computers or similar devices.

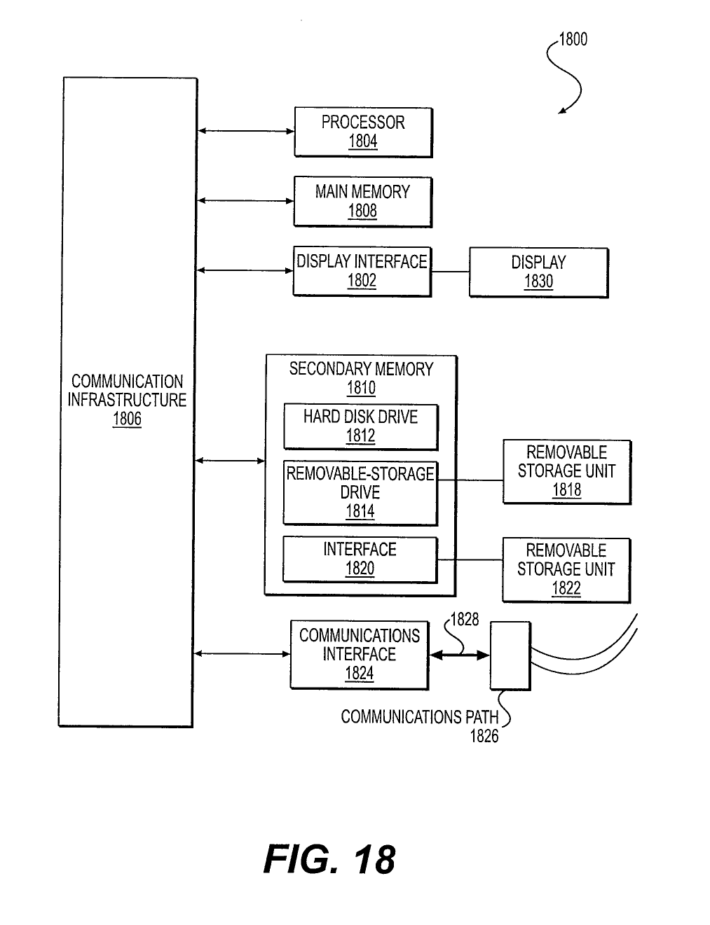

In fact, in one embodiment, the present invention is directed toward one or more computer systems equipped to carry out the functions described herein. An example of such a computer system 1800 is shown in FIG. 18.

Computer system 1800 includes at least one processor 1804. Processor 1804 is connected to a communication infrastructure 1806 (e.g., a communications bus, a cross-over bar device, or a network). Although various software embodiments are described herein in terms of this exemplary computer system 1800, after reading this description, it will become apparent to a person skilled in the relevant art(s) how to implement the invention using other computer systems and/or architectures.

Computer system 1800 includes a display interface 1802 that forwards graphics, text, and other data from communication infrastructure 1806 (or from a frame buffer (not shown)) for display on a display unit 1830.

Computer system 1800 also includes a main memory 1808, which preferably is a random access memory (RAM), and may also include a secondary memory 1810. Secondary memory 1810 may include, for example, a hard disk drive 1812 and/or a removable-storage drive 1814 (e.g., a floppy disk drive, a magnetic tape drive, an optical disk drive, and the like). Removable-storage drive 1814 reads from and/or writes to a removable storage unit 1818 in a well-known manner. Removable storage unit 1818 may be, for example, a floppy disk, a magnetic tape, an optical disk, and the like, which is written to and read by removable-storage drive 1814. As will be appreciated, removable storage unit 1818 includes a computer-usable storage medium having stored therein computer software and/or data.

In alternative embodiments, secondary memory 1810 may include other similar devices for allowing computer programs or other instructions to be loaded into computer system 1800. Such devices may include a removable storage unit 1822 and an interface 1820 (e.g., a program cartridge and a cartridge interface similar to those used with video game systems); a removable memory chip (e.g., an erasable programmable read-only memory (“EPROM”) or a programmable read-only memory (“PROM”)) and an associated memory socket; and other removable storage units 1822 and interfaces 1820 that allow software and data to be transferred from removable storage unit 1822 to computer system 1800.

Computer system 1800 may also include a communications interface 1824, which allows software and data to be transferred between computer system 1800 and external devices (not shown). Examples of communications interface 1824 may include a modem, a network interface (e.g., an Ethernet card), a communications port, a Personal Computer Memory Card International Association (“PCMCIA”) interface, and the like. Software and data transferred via communications interface 1824 are in the form of signals 1828, which may be electronic, electromagnetic, optical or another type of signal that is capable of being received by communications interface 1824. Signals 1828 are provided to communications interface 1824 via a communications path 1826 (e.g., a channel). Communications path 1826 carries signals 1828 and may be implemented using wire or cable, fiber optics, a telephone line, a cellular link, a radio-frequency (“RF”) link, or the like.

As used herein, the phrases “computer program medium” and “computer usable medium” may be used to refer generally to removable storage unit 1818 used with removable-storage drive 1814, a hard disk installed in hard disk drive 1812, and signals 1828, for example. These computer program products provide software to computer system 1800. The present invention may be implemented or embodied as one or more of such computer program products.

Computer programs (also referred to as computer control logic) are stored in main memory 1808 and/or secondary memory 1810. The computer programs may also be received via communications interface 1824. Such computer programs, when executed, enable computer system 1800 to perform the features of the present invention, as discussed herein. In particular, the computer programs, when executed, enable the processor 1804 to perform the features of the present invention.

Accordingly, such computer programs represent controllers of computer system 1800.

In an embodiment where the present invention is implemented using software, the software may be stored in a computer program product and loaded into computer system 1800 using removable-storage drive 1814, hard drive 1812, or communications interface 1824. The control logic (software), when executed by processor 1804, causes processor 1804 to perform the functions of the present invention as described herein.

In another embodiment, the present invention is implemented primarily in hardware using, for example, hardware components such as application-specific integrated circuits (“ASICs”). Implementation of such a hardware arrangement so as to perform the functions described herein will be apparent to persons skilled in the relevant art(s).

In yet another embodiment, the present invention is implemented using a combination of both hardware and software.

As will be appreciated by those of skill in the relevant art(s), the present invention may be implemented using a single computer or using a computer system that includes multiple computers each programmed with control logic to perform various of the above-described functions of the present invention.

### V. CONCLUSION

The various embodiments of the present invention described above have been presented by way of example and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents. It is also to be understood that the steps and processes recited in the claims need not be performed in the order presented.

In addition, it should be understood that the attached drawings, which highlight the functionality and advantages of the present invention, are presented as illustrative examples. The architecture of the present invention is sufficiently flexible and configurable, such that it may be utilized (and navigated) in ways other than that shown in the drawings.

Further, the purpose of the appended Abstract is to enable the U.S. Patent and Trademark Office and the public generally, and especially scientists, engineers, and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present invention in any way.

What is claimed is:

1. A computer-usable medium having control logic stored therein for an evaluation program that causes a computer to enable a supervisor of a group in an organization to input performance evaluations for members of the group, the control logic comprising:
first computer-readable program code for causing the computer to present to the supervisor an electronic evaluation form that includes evaluation items that are answered by selecting one of a plurality of options,
wherein the evaluation form evaluates at least: a plurality of parameters, a plurality of sub-parameters, a plurality of skill types, and a plurality of skill levels, and
wherein each evaluation item is categorized by at least: a parameter, a sub-parameter, a skill type, and a skill level;
second computer-readable program code for causing the computer to receive answers to the evaluation items inputted by the supervisor for each of the members of the group; and
third computer-readable program code for causing the computer to produce a graphical evaluation result based on the answers inputted by the supervisor.

2. The computer-usable medium according to claim 1, wherein the graphical evaluation result is at least one of: a spreadsheet, a pie chart, a bar-graph chart, and a histogram.

3. The computer-usable medium according to claim 1, wherein the control logic further comprises:
fourth computer-readable program code for causing the computer to enable a user to select a subset of the answers inputted by the supervisor,
wherein the graphical evaluation result produced by the computer graphically depicts the subset selected by the user.

4. The computer-usable medium according to claim 3, wherein the graphical evaluation result is a graphical parameter report.

5. The computer-usable medium according to claim 3, wherein the graphical evaluation result is a graphical sub-parameter report.

6. The computer-usable medium according to claim 3, wherein the graphical evaluation result is a graphical profile report relating to at least one of the plurality of skill levels.

7. The computer-usable medium according to claim 1, wherein the control logic further comprises:
fifth computer-readable program code for causing the computer to correlate the answers inputted by the supervisor with other answers inputted by at least one other supervisor in the organization,
wherein the graphical evaluation result produced by the computer graphically depicts a combination of at least a subset of the answers inputted by the supervisor and at least a subset of the other answers inputted by the at least one other supervisor.

8. The computer-usable medium according to claim 1, wherein the evaluation program is a spreadsheet program.

9. The computer-usable medium according to claim 1, wherein the control logic further comprises:
sixth computer-readable program code for causing the computer to enable an authorized user to perform maintenance to the evaluation program.

10. The computer-usable medium according to claim 9, wherein the maintenance includes at least one of: an adding operation, an editing operation, and a deleting operation, and the maintenance is performed on the evaluation form.

11. The computer-usable medium according to claim 10, wherein the maintenance to the evaluation form updates at least one of: a parameter, a sub-parameter, a skill type, and a skill level.

12. The computer-usable medium according to claim 1, wherein the control logic further comprises:
seventh computer-readable program code for causing the computer to provide at least one login interface with password security.

13. The computer-usable medium according to claim 1, wherein the control logic further comprises:
eighth computer-readable program code for causing the computer to compare the answers inputted by the supervisor with other answers inputted by at least one other supervisor in the organization,
wherein the graphical evaluation result produced by the computer graphically depicts a comparison of at least a subset of the answers inputted by the supervisor and at least a subset of the other answers inputted by the at least one other supervisor.

14. The computer-usable medium according to claim 13, wherein said eighth computer-readable program code enables the computer to perform such comparison even if the supervisor belongs to a first business area of the organization, and the at least one other supervisor belongs to at least one other business area of the organization.

15. The computer-usable medium according to claim 1, wherein the control logic further comprises:
ninth computer-readable program code for causing the computer to save changes to the evaluation form to complete at a later time or finalize the evaluation form.

16. The computer-usable medium according to claim 1, wherein the control logic further comprises:
tenth computer-readable program code for causing the computer to compress the evaluation form and export the electronic evaluation form to the authorized user.

17. The computer-usable medium according to claim 1, wherein the graphical evaluation result is a graphical profile report depicting best and worst performing members.

18. The computer-usable medium according to claim 1, wherein the graphical evaluation result is a customized graphical profile report.

19. The computer-usable medium according to claim 18, wherein the customized graphical profile report is provided with filters to permit the user to select evaluation items to be viewed in the report.

20. The computer-usable medium according to claim 1, wherein each evaluation item can be mapped with the supervisor for the group and/or the members of the group.

21. The computer-usable medium according to claim 12, wherein the control logic further comprises:
eleventh computer-readable program code for causing the computer to provide a second login interface with password security unique to the authorized user.

22. A computer system comprising a processor and a memory storing the control logic of claim 1 for causing the processor to enable a supervisor of a group in an organization to input performance evaluations for members of the group.
